(19) United States
(12) Patent Application Publication
(10) Pub. No.: US 2023/0090197 A1
(43) Pub. Date: Mar. 23, 2023

(54) PROTECTIVE DEVICE FOR DRILL CHUCK HAVING A MIXED GASKET WITH INDEPENDENT MOVING FINS

(71) Applicant: INVNOBEL S A S, Bogota (CO)

(72) Inventors: Victor Martin BAYONA SALAZAR, Bogata (CO); Rafael Ricardo MOLANO CAMACHO, Bogata (CO)

(21) Appl. No.: 17/815,370

(22) Filed: Jul. 27, 2022

(30) Foreign Application Priority Data
Sep. 17, 2021 (CO) NC2021/0012219

(51) Int. Cl. B23B 31/00

(52) U.S. Cl. CPC B23B 31/001

(57) ABSTRACT

A protective device is provided that covers a drill chuck to protect it from dust or debris that may be released when a material is being drilled. The protective device has a mixed gasket comprising two sheets with fins that in their central part have independent movement where both are perforated (female type), while the other sheet contains caps (males) that are joined for better manufacturing, wherein said males are long so that they pierce the female holes and embed themselves in a base that is located directly in the protective device, allowing its adequate fastening.

### RELATED APPLICATION

This application claims priority from Colombian Patent Application No. NC2021/0012219, filed Sep. 17, 2021, the entire disclosure of which is incorporated herein by reference.

### TECHNICAL FIELD

The present invention falls in the technical field of devices that are used as accessories for currently known drills, specifically for the protection thereof or that help in the task performed.

Thus, the present invention relates to a protective device that covers the drill chuck and the chuck of a drill to protect them from dust or debris that may be released when a specific material is being drilled, wherein said protective device has a mixed gasket comprising two sheets with fins that in their central part have independent movement where both are perforated, that is, female type, while the other sheet contains caps called males and that are joined for better manufacturing, wherein said males are long so that they pierce the female holes and are embed themselves in a base that is located directly in the protective device, allowing its adequate fastening and fulfilling the defined goal. Similarly, the protective device has a fastening strap that surrounds the back of the drill, securing it in position and preventing it from coming loose or releasing from the drill.

### BACKGROUND OF THE INVENTION

Currently, the use of drills is widely known and applicable in many industries, even for home use it is highly desired when it is required to make a hole in any type of material, such as wood, metal, cement, etc.

Thus, when a drill is used, it is necessary to install a drill bit, which is located in the drill chuck of said device and is the one that drills the desired material. However, when working with materials that have a high content of waste, especially when said materials produce residues, said residues can be detrimental to the drill as such, since these usually fall into the drill through the chuck, a fact that it is totally unwanted and can lead to a malfunction of the device, or can even get stuck inside and cause relatively serious problems for the user, leading to total damage to the drill in most cases.

In this regard, there are different types of protective elements for drills that are usually used to prevent this type of residue from affecting both the user and the drill, and allow proper operation of the device, wherein these protective elements are widely known in the state of the art.

Thus, in the state of the art several types of protective elements are known, among which are the following, which are included in the present disclosure as reference only.

Firstly, document EP3352839 relates to an introducer sheath system including an introducer sheath defining a lumen and having a proximal valve housing in fluid communication with a distal tubular sheath, wherein a proximal end of the valve housing defines a proximal opening of the lumen of the introducer sheath. A gasket seated within the valve housing has a first surface, a second surface, and an outer periphery extending between the first and second surfaces. A first groove is formed in the first surface having an inner surface defining a first space. A second groove formed in the second surface having an inner surface defining a second space. A notch extends into the first space of the first groove forming a bulge on the inner surface of the first groove, where the second groove intersects the first groove in the notch so that the notch prevents the first and second grooves from being in fluid communication.

Similarly, document CN208375223 discloses a dust collector for drilling holes, which belongs to the technical field of drill bits, including a honeycomb duct, drill tube, soft rubber gasket ring, elastic rubber dust-proof port, dust bag and clip. The bit passes the dust-proof elastic rubber port slot that enters the bit tube when used, the wall to be drilled closely hugs the soft rubber gasket ring at the bevel connection of one end of the duct honeycomb collecting duct, when starting electric hand drilling or hammer drill drilling hole, the dust piece coming out from drilling flows into the dust bag through the ground honeycomb duct under the effect of gravity, the soft rubber gasket ring and the elastic rubber dust-proof port stop out the piece of dust coming out from the honeycomb collection duct drilling of drill bit and the drill pipe being drilled, when the drilling is completed, the drill bit is pulled out, the fastener is loosened, the dust bag is removed, disposing the dust bag quickly.

On the other hand, document CN207853204 relates to a dust-preventing cable cover switch plate, the intelligent cabinet temperature adjustment device comprises a cabinet body, wherein the cabinet body is equipped with a pre-partition switch door, has a multi-unit ventilation grille to go through the face of the left and right sides of the cabinet body, the dust filter device is installed on the inner wall of the face of the left and right sides of the cabinet body, the lower part of the cabinet body is equipped with the top of the outdoor rainproof slope, the rear bottom of the cabinet body runs through a plurality of cable hole, the cable hole is equipped with the mounting pad facing out, the connection seat is installed on the mounting pad, which is equipped with a dust-proof gasket between the mounting pad and the connection seat, where the connection seat that connects outwards has the arc sheath all equipped with the cable passage in the mounting pad, connection seat, the arc sheath bow. Also, it reveals a dust-proof gasket between the mounting plate and the connection seat which effectively prevents normal work dust from entering the internal electrical influencing elements of the cabinet from the cable hole, and the arc cover can make the cable pass slowly to hang down, avoiding cable breaking, and also protect the cable.

Similarly, document US 20170252833, which corresponds to U.S. application Ser. No. 15/039,991, discloses a self-retracting telescopic device, made of a rigid material, which can be installed in all the types of drills, both for home and industrial, both wired and wireless, where said device adapts to the base where the chuck holds the drill bit in the felling, thus completely covering the drill and thus avoiding the risk of contact with the operator hands on the drill. The device allows defining a measurement according to the desired drilling need and allows this to be done perfectly, that is, establishing a measurement as far as the drill bit enters. In addition, the device allows the proper collection of waste or debris expelled when the drilling process is carried out, thus protecting the drill and increasing its life by isolating it from waste or debris that may be released during the operation.

However, this document has the drawback that it is a rigid element that covers the entire drill, which may be undesirable because it does not allow flexible handling and that the operator can modify it according to needs. In addition, by covering the drill completely, it requires different sizes to fit all the existing drills. In addition, it requires considerable installation time, which increases operating costs because its efficiency is not improved.

On the other hand, Colombian patent application CO12-198323 relates to a device to cover the drill and the chuck in a drill, as well as its assembly process, where said device allows to cover the drill and the chuck and its objective is to provide protection to the operator against the risks related to the drilling operation that can be presented by the rotating bit, in addition to facilitating the handling of the drill and collecting the dust produced by its use. All of the above is achieved without affecting the free rotation of the chuck. Thus, the device covers the drill and is installed on the chuck easily and quickly and retracts as the drill penetrates the surface. The device basically consists of three superimposed tubes, which correspond to a coupling tube, a connecting tube and a sliding tube.

However, the invention defined in said anteriority has the disadvantage that it is not a flexible element that can be adjusted to any drill bit type or size and drill chuck, while avoiding the entering of dust or debris in the drill, in order to conserve it and prolong its lifespan.

Now, document AU2005202845 teaches a powder containment apparatus for use in a drill, wherein the apparatus includes a container having an open end and an opening in the container. A drill can pass through the opening such that a free working end of the drill can extend from the container at the open end towards a work surface during operation of the drill. A sealing means forms a substantially impermeable dust seal between the container and the drill. The open end of the container can be held against the work surface to form a seal therewith during the drilling operation. The apparatus may also include a liquid supply means for introducing a nebulized liquid into the container to moisten dust that is generated during or after the drill operation.

In addition, document CN103831455 discloses a drilling machine gasket, where the cross section of a gasket body is right trapezoidal in shape, the upper surface of the gasket body is provided with a first through hole in the form of a strip, the front surface of the gasket body is provided with a second strip-shaped through hole, and a bolt hole is formed behind the first strip-shaped through hole. Multiple surfaces of the drilling machine gasket are provided with the strip-shaped through holes, the drilling machine gasket vibrates a lot when used, the weakness of the bolt caused by resonance can be effectively prevented through the holes interns cross each other in the form of a strip, and therefore the reliability of the equipment work can be guaranteed.

Similarly, document CN205190736 relates to metal sealing gaskets, wherein the center of the metal gasket has a diameter greater than the inner diameter of the cylinder liner or the inner diameter of the coupling, and there is a metal gasket with a locating hole neighboring, and the center diameter outer punch press forms more than twice the concentric non-smooth reciprocating ring type and the back seal, and it is circular or oval while the metal gasket is a rectangle. The screw and nut through the locating hole tightly compresses the metal gasket, avoiding the defect of flat metal gaskets or rubber sheets, improving the sealing effect and saving material which simplifies assembly, and the lifespan increase also increases the suitability of the sealed product, which achieves energy saving and consumption reduction, and the purpose of cleaner production simultaneously.

Finally, locally in Colombia, the following documents are found, considered to be related in some part to the present invention, such as document CO 14131320 which defines a beverage supply system that includes a container, a mechanism of adhesion, and a cartridge. The container may contain a mixing solution or liquid, such as water, to be mixed with the contents of the cartridge. The adhesion mechanism is generally located inside the container. The adhesion mechanism may comprise a latch assembly, a piercing portion, and a valve assembly. The latch assembly can usually receive the cartridge within the attachment mechanism. The piercing portion may generally pierce the cartridge, thereby releasing the contents of the cartridge into the container. The valve assembly can usually be opened upon engagement of the cartridge with the adhesion mechanism, thereby combining the contents of the cartridge with the liquid within the container to create a drinkable beverage.

Based on the above information, those skilled in the art can clearly determine that in the state of the art there are a series of devices or accessories that can be placed on a drill for collecting waste or dust when using the drill, wherein most of the elements found use a single layer to carry out the collection, a fact that does not ensure its operation and could become entangled with the drill, thus affecting the drill at all times.

However, the accessory devices found in the state of the art feature the problem that they do not adequately ensure that no residue or dust reaches the drill through the chuck, and although they allow a collection of residues, they allow the passage of some quantity thereof that accumulates inside the drill and which will eventually affect its operation.

In addition, most of the accessories found in the state of the art and previously mentioned herein, do not allow a bit to pass through them to achieve the objective of proper collection, while allowing the drill to function as intended and so bit meets its drilling goal. Moreover, none of the documents mentioned above and found in the prior art, allow complete protection of both the chuck and the drill chuck, but simply limit themselves to collecting dust leaving this essential part unprotected, which can lead to damage that can be costly due to the drill elements involved.

In addition to the above, there is a problem in the state of the art related to the rigidity of the currently existing devices that are used to protect the drill, whether covering the entire drill or its drill bit and chuck, a fact that can lead to most of the cases due to breakage in the bit during its operation. Therefore, the use of a rigid material is highly undesirable due to its implications on the drill that breaks it.

### SUMMARY OF THE INVENTION

The present invention proposes a solution to the problem described above by providing a protective device to be placed on the front part of a drill, specifically, a device that covers both the chuck and the drill chuck, and is attached to the back of the drill, that is, on its handle, by means of a fastening strap that surrounds said rear part of the drill, securing the protective element and preventing it from being easily released or from leaving its position due to the vibration produced by the device, wherein said device and mainly its gasket is in constant contact with the drill, even when it is in motion, that is, when it is rotating in its position (in operation).

Thus, the aforementioned problem related to the risk of the drill bit breaking during the operation of the drill is solved thanks to the fact that the device of the present invention is made of a flexible material, that is, not rigid like those existing in the state of the art, while not being thin enough to be loose when being installed, but somewhere between stiff and loose. Moreover, the solution is achieved thanks to the use of two gaskets and their relative position therebetween with a 45° offset, which allows the desired flexibility of the device to be achieved and that the drill can pass through them and ensure that its operation is not affected, even when in motion.

In this regard, the protective device of the present invention has a mixed gasket that is always in contact with the drill bit even when it is in motion, as indicated above, particularly, a rubber gasket for a drill bit, which does not allow residues to pass, wherein said gasket comprises two sheets, a first sheet with at least two central cross-shaped cuts, which generate four segments, and a second sheet with at least two central cross-shaped cuts, which generate four segments.

Thus, the sheets of the mixed gasket of the invention are joined around their perimeter ring, thus guaranteeing that the central area of said sheets, that is, the areas comprising the segments, remain separated and that the cross cuts of the first sheet are rotationally displaced (offset), preferably at an angle of 45° in relation to the cross cuts of the second sheet, so that said cuts do not match.

The arrangement of the mixed gasket blades allows the drill to pass through the point where the cross cuts meet each other, thus also allowing the drill bit to function properly and to perform the drilling function without inconvenience, but protecting inside the hole of debris or dust.

Similarly, the sheets with independent movement fins of the mixed gasket of the present invention are divided so that one of said sheets has a series of perforations and is called a female-type element, while the other sheet contains caps or protrusions called males, which are attached to or form part of the sheet for better manufacturing, wherein said male elements are long so that they can be inserted into the female holes and embedded in a base.

According to the above, the purpose of the protective device with mixed gasket of the present invention is its provision as a cover to protect the drill chuck and not allow debris to enter the drill while a job is being carried out, protecting it in a proper manner.

### BRIEF DESCRIPTION OF THE DRAWINGS

The present invention is understood more clearly from the following figures where the components associated with this device or apparatus are shown, as well as the novel elements with respect to the state of the art, where the figures are not intended to limit the scope of the invention, which is solely defined by the appended claims, wherein:

FIG. 1 corresponds to a perspective view of a commercially available drill, which has the protective device with mixed gasket of the present invention installed on its front part.

FIG. 2 corresponds to an exploded view of the drill of FIG. 1 including the protective device with mixed gasket of the present invention.

FIG. 3 corresponds to an enlarged view of the detail of the joint of the mixed gasket with the rest of the components of the protective device of the present invention, while it is installed in a hole.

FIGS. 4A-D correspond to different views of the mixed gasket with independent fins being part of the protective device of the present invention.

FIGS. 5A-C correspond to different views of the external casing of the protective device of the present invention.

FIGS. 6A-B correspond to different views of the clamp being installed in the lower part of the external casing and being part of the protective device of the present invention. Specifically, FIG. 6A shows a rubber clamp whose upper half is tapered to fit any tip of the chuck.

FIGS. 7A-C correspond to different views of the fastening strap that surrounds the rear part of the drill in operation, which is part of the protective device of the present invention.

### DETAILED DESCRIPTION OF THE INVENTION

The present invention is directed to a protective device to be installed on the front of a commercially available drill, wherein said protective device covers the drill chuck and protects said component from debris and/or dust that may be released when the drilling process is carried out by the user.

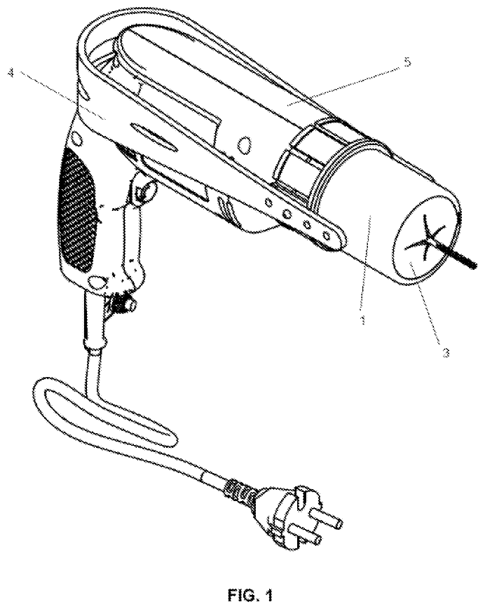

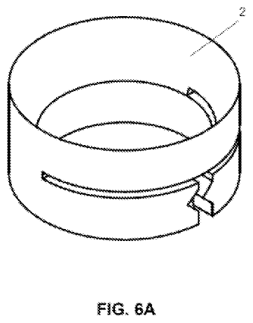

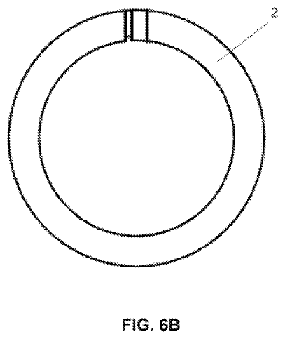

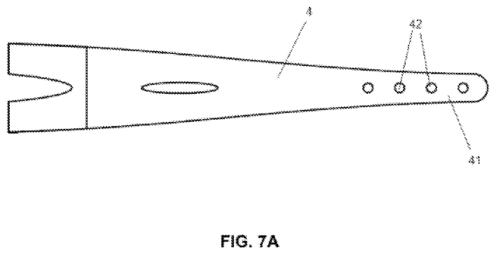

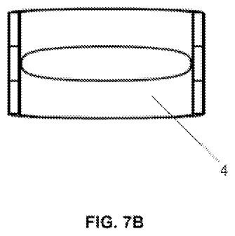

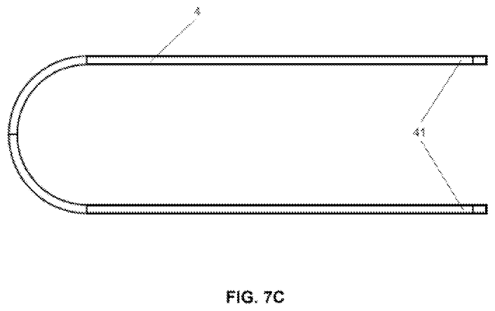

In this regard, FIGS. 1 to 7 show a protective device for the front part of a drill, as defined in the previous paragraph, wherein said protective device is installed in a simple and comfortable way, ensuring that it is not released from the drill during its operation and that the drill bit can pass therethrough and fulfill its drilling goal, wherein said protective device is generally composed of the following parts or components:

An external body or casing (1) installed on the outside surrounding the front part of the drill (5), specifically on the drill chuck of said apparatus, wherein the external body or casing (1) has a substantially cylindrical shape and has an upper section (11) and a lower section (12), where the upper section (11) has a cover (13) with a plurality of holes (14) arranged on the surface thereof, while the lower section (12) has a larger diameter than the upper section (11) and is divided into sections and has a pair of protruding elements (15) arranged diametrically opposite;

A clamp (2) which fits inside the lower section (12) of the external casing (1), wherein said clamp wraps around the drill chuck (5);

A mixed gasket (3) made up of two sheets (31, 32) joined together by a joining element (33), wherein each of said sheets (31, 32) has at least two central cross-shaped cuts that create a series of independently moving fins (34), wherein the first sheet (31) has a series of female holes (35) around it, and the second sheet (32) has a series of male caps (36) that match with the female holes (35) and are inserted therein when folding the second sheet (32) over the first sheet (31) at the joint (33); and

A fastening strap (4) that surrounds the back of the drill (5) when the device is installed, wherein said fastening strap (4) has a front end made up of two ends (41) that have a series of holes (42) in which the protruding elements (15) of the external casing (1) are inserted to fasten the protective device to the drill (5), while the opposite end, i.e., the rear end of the fastening strap (4), has a curvature that fits the shape of the drill (5).

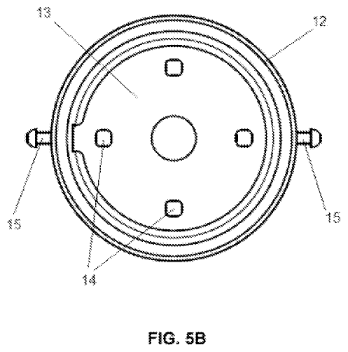

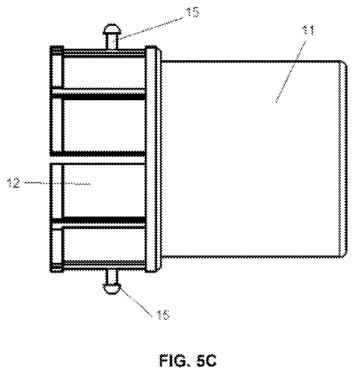

Thus, FIGS. 5A-D specifically show the holes (14) of the cover (13) of the external casing (1), which are used to receive the male caps (36) of the second sheet (32) when the mixed gasket (3) is folded, in order to allow said gasket (3) to be installed on the external casing (1).

According to the above, the number of holes (14) on the cover (13) of the external casing (1), matches with the number of female holes (35) of the first sheet (31) and the male caps (36) of the second sheet (32). Although a predefined number of these elements is illustrated in the Figures, the present disclosure contemplates any number of these, such as, for example, at least 2, at least 4, at least 6, at least 8, or even, at least 10, without limitations, wherein said number depends directly on the size of the protector of the present invention and the hole in which it is going to be installed.

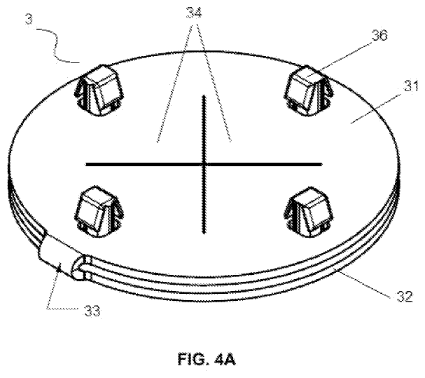

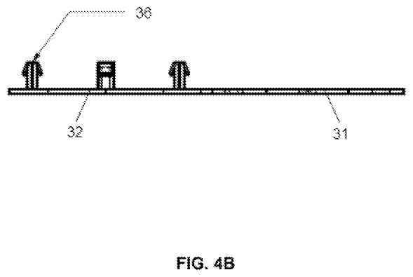

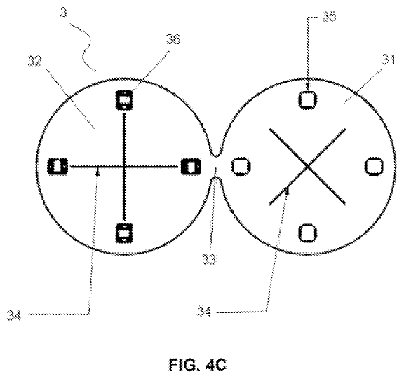

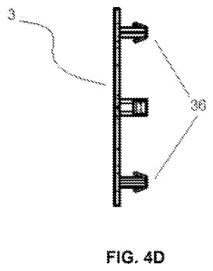

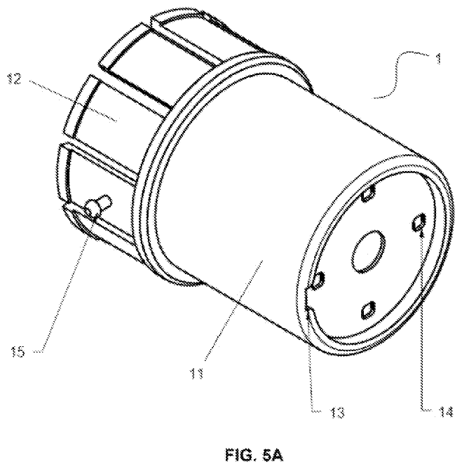

In a preferred embodiment, as illustrated in detail in FIG. 4, the central cross-shaped cuts that create a series of independently moving fins (34) of the sheets (31, 32), are offset from each other. Preferably, said offset is 45°, which creates eight independent fins (34) that do not match with each other, but are offset when locating the second sheet (32) on the first sheet (31).

This offset of the independently moving fins (34) allows the drill bit to pass through the protective device without any problem, that is, it can fulfill its objective, while preventing debris or dust from entering the protective device, since the crosses that create said fins (34) do not match and, therefore, the dust cannot pass. Likewise, the arrangement of fins (34) allows the material from which they are made to return to its original position, since there will always be resistance to the movement exerted by the drill bit when the protective device is installed in the drill (5).

In a preferred embodiment of the present invention, the clamp (2) has an (imaginary) division between its upper part and the lower part, wherein it is desirable that the upper half of said clamp (2) have a conical shape, similar to a truncated cone, in order to adapt to any chuck tip without limitations, that is, to adapt adequately to any type of drill.

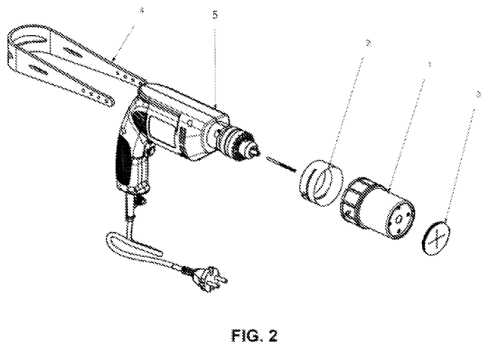

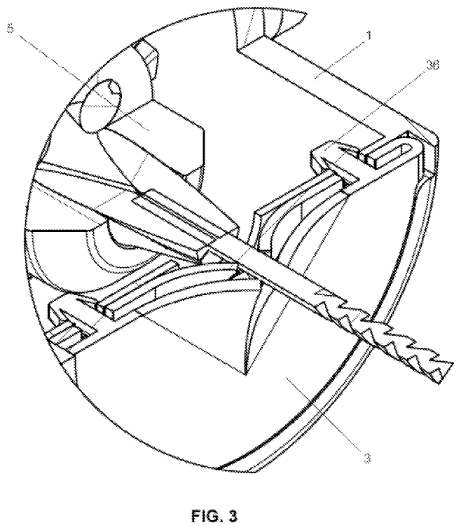

For installing the protective device of the present invention, as illustrated in FIG. 2, it is first necessary to insert the drill bit into the drill chuck (5), then the clamp (2) is inserted by sliding it into the chuck surrounding it, to then be able to insert the outer casing (1) so that the clamp (2) is inside the lower section (12). Then, the flexible gasket (3) must be formed by folding the second section (32) over the first section (31) and thus the male caps (36) can be inserted into the holes (14) of the cover (13) of the outer casing (1), thus the flexible gasket (3) is fully secured in the casing (1).

Once the clamp (2), the external casing (1) and the mixed packing (3) have been installed, the protective device is secured to the drill (5) to prevent it from coming out or being separated and it can drill without any problems. Thus, the fastening strap (4) is directly attached to the external casing (1) by inserting the protruding elements (15) of the lower section (12) into the holes (42) found at the ends (41) of said fastening strap (4).

According to the above definition, it is important to bear in mind that one of the main advantages of the present invention is that it can be adapted to any type of drill, without limitations, a fact that was not possible to obtain with similar devices existing in the state of the art as mentioned above in the background section.

Although the previous description defines the preferred embodiments of the present invention, several modifications that may be evident to those skilled in the art are also contemplated within the scope of this document, wherein said scope is not in any way limited to the embodiments, but it is defined solely by the appended claims and the subject-matter therein.

1. A drill chuck protective device configured to protect a drill chuck of a drill, the drill chuck protective device comprising:
an external casing installed on an outside surface surrounding a front part of the drill, wherein said external casing has an upper section and a lower section, where the upper section has a cover with holes arranged on the surface thereof, while the lower section has a larger diameter than the upper section and is divided into sections and has a pair of protruding elements;
a clamp which fits inside the lower section of the external casing and wraps around the drill chuck;
a mixed gasket composed of two sheets joined together by a joining element, wherein each of said sheets has at least two central cross-shaped cuts that create independently moving fins, wherein the first sheet has female holes around it, and the second sheet has male caps that match with the female holes; and
a fastening strap that surrounds a back surface of the drill when the device is installed, wherein said fastening strap has a front end made up of two end portions having holes to receive the protruding elements of the external casing.

2. The protective device according to claim 1, wherein the external body or casing is cylindrically shaped.

3. The protective device according to claim 1, wherein the protruding elements of the lower section of the external casing are arranged in a diametrically opposed manner.

4. The protective device according to claim 1, wherein the number of holes of the cover in the external casing matches the number of female holes in the first sheet and the number of male caps in the second sheet.

5. The protective device according to claim 4, wherein the number of holes is 4 or more.

6. The protective device according to claim 1, wherein the central cross-shaped cuts that create the independently moving fins of the sheets, are offset from each other.

7. The protective device according to claim 6, wherein the offset of the central cross-shaped cuts is 45°.

8. The protective device according to claim 1, wherein the rear end of the fastening strap has a curvature that fits a predetermined shape of the drill.

9. The protective device according to claim 1, wherein the clamp is divided into two halves, wherein an upper half has a conical, truncated cone shape.
